(19) United States
(12) Patent Application Publication
(10) Pub. No.: US 2022/0391776 A1
(43) Pub. Date: Dec. 8, 2022

(54) ORCHESTRATION OF MULTI-CORE MACHINE LEARNING PROCESSORS

(71) Applicant: Texas Instruments Incorporated, Dallas, TX (US)

(72) Inventors: Mihir Narendra MODY, Bengaluru (IN); Kumar DESAPPAN, Bengaluru (IN); Kedar Satish CHITNIS, Bengaluru (IN); Pramod Kumar SWAMI, Bengaluru (IN); Kevin Patrick LAVERY, Sugar Land, TX (US); Prithvi Shankar YEYYADI ANANTHA, Bengaluru (IN); Shyam JAGANNATHAN, Bengaluru (IN)

(21) Appl. No.: 17/342,037

(22) Filed: Jun. 8, 2021

(51) Int. Cl. G06N 20/20; G06F 9/52; G06F 9/455

(52) U.S. Cl. CPC G06N 20/20; G06F 9/52; G06F 9/455

(57) ABSTRACT

Techniques for executing machine learning (ML) models including receiving an indication to run a ML model, receiving synchronization information for organizing the running of the ML model with other ML models, determining, based on the synchronization information, to delay running the ML model, delaying the running of the ML model, determining, based on the synchronization information, a time to run the ML model; and running the ML model at the time.

### BACKGROUND

Machine learning (ML) is becoming an increasingly important part of the computing landscape. Machine learning is a branch of artificial intelligence (AI) and ML helps enable a software system to learn to recognize patterns from data without being directly programmed to do so. Neural networks (NN) are a type of ML which utilize a set of linked and layered functions (e.g., nodes, neurons, etc.) which are weighted to evaluate input data. In some NNs, sometimes referred to as convolution neural networks (CNNs), convolution operations are performed in NN layers based on inputs received and weights rather than matrix multiplication used in traditional NN. Layers in CNNs may perform many types of functions; including, but not limited to, convolution, deconvolutional, pooling, up-sample, etc. CNNs are often used in a wide array of applications typically for recognition and classification, such as image recognition and classification, prediction and recommendation systems, speech and language recognition and translation, etc.

As ML becomes increasingly useful, there is a desire to execute complex ML techniques, such as NNs and CNNs, efficiently in devices with relatively limited compute and memory resources, such as embedded, or other low-power devices. To help efficiently run a given ML model, the ML mod& may be analyzed and optimized to tailor how the ML model is run to a target hardware resources to be used.

### SUMMARY

This disclosure relates to a technique for executing machine learning (ML) models. The technique includes receiving an indication to run a ML model, receiving synchronization information for organizing the running of the ML model with other ML models, determining, based on the synchronization information, to delay running the ML model, delaying the running of the ML model, determining, based on the synchronization information, a time to run the ML model; and running the ML model at the time.

Another aspect of the present disclosure relates to a non-transitory program storage device comprising instructions stored thereon to cause one or more processors to receive a set of ML models, simulating running the set of ML models on a target hardware to determine resources required by the ML models of the set of ML models and timing information, determining to delay running one or more ML models of the set of ML models based on the simulation, and generating synchronization information based on the determining.

Another aspect of the present disclosure relates to an electronic device, comprising a memory, and one or more processors operatively coupled to the memory, wherein the one or more processors are configured to execute instructions causing the one or more processors to receive an indication to run a machine learning (ML) model, receive synchronization information for organizing the running of the ML model with other ML models, determine, based on the synchronization information, to delay running the ML model, delay the running of the ML model, determine, based on the synchronization information, a time to run the ML model, and run the ML model at the time.

### BRIEF DESCRIPTION OF THE DRAWINGS

For a detailed description of various examples, reference will now be made to the accompanying drawings in which:

FIG. 1 illustrates an example neural network ML model, in accordance with aspects of the present disclosure.

FIG. 2 is a block diagram of a device including hardware for executing ML models, in accordance with aspects of the present disclosure.

FIG. 3 is a block diagram of a process for preparing ML models for target hardware, in accordance with aspects of the present disclosure.

FIG. 4 is a timeline illustrating ML model execution across the computing cores, in accordance with aspects of the present disclosure.

FIG. 5 is a timeline illustrating ML model execution across the computing cores, in accordance with aspects of the present disclosure.

FIGS. 6A-6B are tables illustrating context information for coordinating ML model execution, in accordance with aspects of the present disclosure.

FIG. 7 is a flowchart illustrating a leaky bucket optimization scheme, in accordance with aspects of the present disclosure.

FIG. 8 is a block diagram illustrating context information locking, in accordance with aspects of the present disclosure.

FIG. 9 is a block diagram of a process for optimizing ML model execution, in accordance with aspects of the present disclosure.

FIG. 10 is a flow diagram illustrating a technique for synchronizing a ML model, in accordance with aspects of the present disclosure.

FIG. 11 is a flow diagram illustrating a technique for synchronizing a ML model, in accordance with aspects of the present disclosure

### DETAILED DESCRIPTION

As ML has becoming more common and powerful, hardware configured to execute ML models has been introduced. As used herein, an ML model may refer to an implementation of one or more ML algorithms which model a behavior, such as object recognition, behavior of a circuit, behavior of a neuron, etc. In cases where a target hardware for executing ML models are known, the ML models may be optimized for the target hardware configurations to help enhance performance. For example, ML models for object recognition, low-light enhancement, and facial recognition may be optimized to execute on a particular a mobile device, such as a smartphone configured with a certain ML processor. As another example, ML models for object recognition, movement prediction, and behavioral prediction may be optimized to execute on specific hardware found in certain partially or fully self-driving automobiles.

### Example ML Model

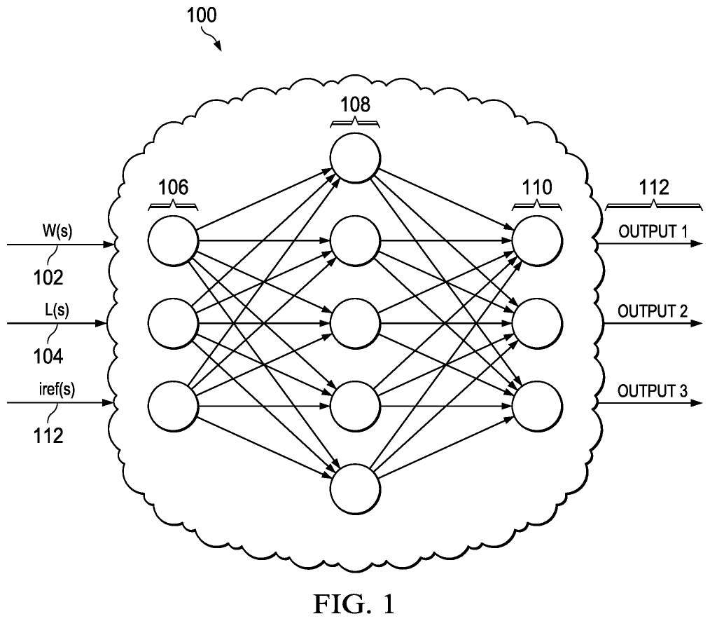

FIG. 1 illustrates an example neural network ML model 100, in accordance with aspects of the present disclosure. The example neural network ML model 100 is a simplified example presented to help understand how a neural network ML model 100, such as a CNN, is structured and trained. Examples of neural network ML models may include LeNet, Alex Net, Mobilnet, etc. It may be understood that each implementation of a ML model may execute one or more ML algorithms and the ML model may be trained or tuned in a different way, depending on a variety of factors including, but not limited to, a type of ML model being used, parameters being used for the ML model, relationships as among the parameters, desired speed of training, etc. In this simplified example, parameters values of W, L, and iref are parameter inputs 102, 104, and 112 are passed into the ML model 100. Each layer (e.g., first layer 106, second layer 108, and third layer 110) includes a plurality of nodes (e.g., neurons) and generally represents a set of operations performed on the parameters, such as a set of matrix multiplications, convolutions, deconvolutions, etc. For example, each node may represent a mathematical function that takes, as input (aside from the nodes of the first layer 106), output from a previous layer and a weight. The ML model outputs 112 are output from the last layer (e.g., the third layer 110). The weight is typically adjusted during ML model training and fixed after the ML model training. The specific mathematical function of the node can vary depending on ML model implementation. While the current example addresses three layers, in certain cases the ML model may include any number of layers. Generally, each layer transforms M number of input parameters to N number of output parameters. The parameter inputs to the first layer 106 are output as inputs to the second layer 108 with a set of connections. As each node of a layer (such as first layer 106) outputs to each node in a subsequent layer (such as second layer 108), ML model 100 is a fully connected neural network. Other embodiments may utilize a partially connected neural network or another neural network design which may not connect each node of a layer to each node of a subsequent layer, where some node connections may skip layers, where no feedback is provided from output to inputs (e.g. Feed Forward CNN), etc.

In this example, first layer 106 represents a function based on a set of weights that are applied to the input parameters (e.g., input parameters 102 and 104) to generate output from first layer 106 that is input to the second layer 108. Different weights may be applied for the input received from each node of the previous layer by the subsequent layer. For example, for a node of the second layer 108, the node applies weights to input received from nodes of the first layer 106 and the node may apply a different weight to input received from each node of the first layer 106. Nodes compute one or more functions based on the inputs received and corresponding weights and outputs a number. For example, the node may use a linear combination function which multiplies an input values from a node of the previous layer with a corresponding weight and sums across the results of the multiplication, coupled with a non-linear activation function which acts as a floor for the resulting number for output. It may be understood that any known weighted function may be applied by the node within the scope of this disclosure. This output number may be input to subsequent layers, or if the layer is a final layer, such as third layer 110 in this example, the number may be output as a result (e.g., output parameters or ML model outputs 112).

In some cases, the functions applied by nodes of a layer may differ as between layers. In some cases, each layer may have different resource requirements. For example, different functions may have different loads on the processor. Additionally, some functions may have different input or output parameters and thus consume more, or less, memory space and bandwidth. These differing processor and memory loads may also influence an amount of energy to power the processor and memory, as well as an amount of heat generated.

After a ML model, such as neural network ML model 100, is defined with respect to nodes, layers, etc., the ML model may be trained. In some cases, the ML model 100 may be trained using a labelled data set corresponding to data to be input to ML model 100. For example, an object recognizer may be trained on images of objects. These images may include metadata labelling the object(s) in the image. The ML model 100 may be initiated with initial weights and the images input to the ML model 100 to generate predictions. The weights of the nodes may be adjusted based on how accurate the prediction is as compared to the labels. The weights applied by a node may be adjusted during training based on a loss function, which is a function that describes how accurately the predictions of the neural network are as compared to the expected results; an optimization algorithm, which helps determine weight settings adjustments based on the loss function; and/or a backpropagation of error algorithm, which applies the weight adjustments back through the layers of the neural network. Any optimization algorithm (e.g., gradient descent, mini-batch gradient descent, stochastic gradient descent, adaptive optimizers, momentum, etc.), loss function (e.g., mean-squared error, cross-entropy, maximum likelihood, etc.), and backpropagation of error algorithm (e.g., static or recurrent backpropagation) may be used within the scope of this disclosure.

In some cases, training the ML model 100 is performed during development of the ML model 100 and may be performed by a system or device separate from the system or device that runs the trained ML model.

### Example Hardware for Executing ML Models

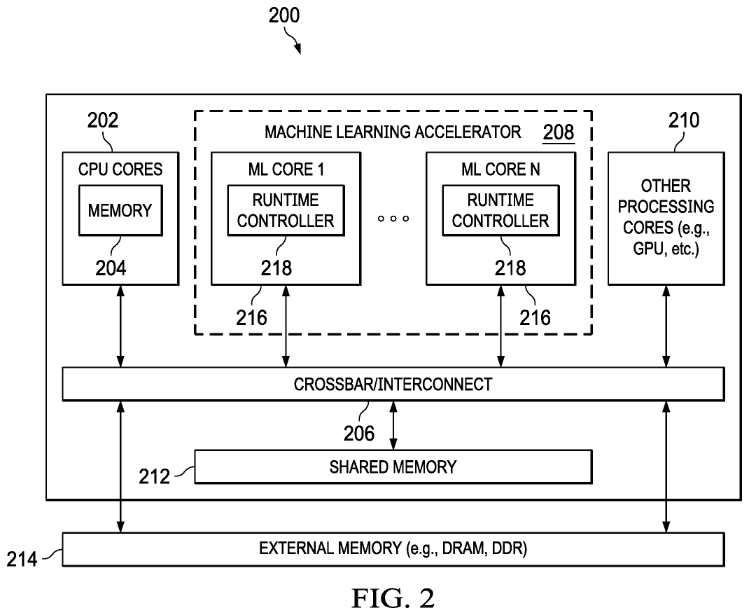

FIG. 2 is a block diagram 200 of a device including hardware for executing ML models, in accordance with aspects of the present disclosure. The device may be system on a chip (SoC) including multiple components configured to perform different tasks. As shown, the device includes one or more central processing unit (CPU) cores 202, which may include one or more internal cache memories 204. The CPU cores 202 may be configured for general computing tasks.

The CPU cores 202 may be coupled to a crossbar (e.g., interconnect) 206, which interconnects and routes data between various components of the device. In some cases, the crossbar 206 may be a memory controller or any other circuit that can provide an interconnect between peripherals. Peripherals may include master peripherals (e.g., components that access memory, such as various processors, processor packages, direct memory access/input output components, etc.) and slave peripherals (e.g., memory components, such as double data rate random access memory, other types of random access memory, direct memory access/input output components, etc.). In this example, the crossbar 206 couples the CPU cores 202 with other peripherals, such as a ML accelerator 208 and other processing cores 210, such as a graphics processing unit, radio basebands, coprocessors, microcontrollers, etc., one or more shared memories 212, as well as external memory 214, such as double data rate (DDR) memory, dynamic random access memory (DRAM), flash memory, etc., which may be on a separate chip from the SoC. The shared memory 212 may include any type of memory, such as static random access memory (SRAM), flash memory, etc. The ML accelerator 208 may include one or more ML cores 216. The ML cores 216 may be processor cores configured to accelerate machine learning models. A runtime controller 218 for controlling ML model execution and interfacing between the ML model and the ML cores 216 may execute on the ML cores. The runtime controller 218 may be software based, for example, an operating system, kernel, and/or hypervisor. In some cases, the runtime controller 218 may include hardware configured to control and/or manage execution of ML models on one or more ML cores 216.

ML Model Preparation

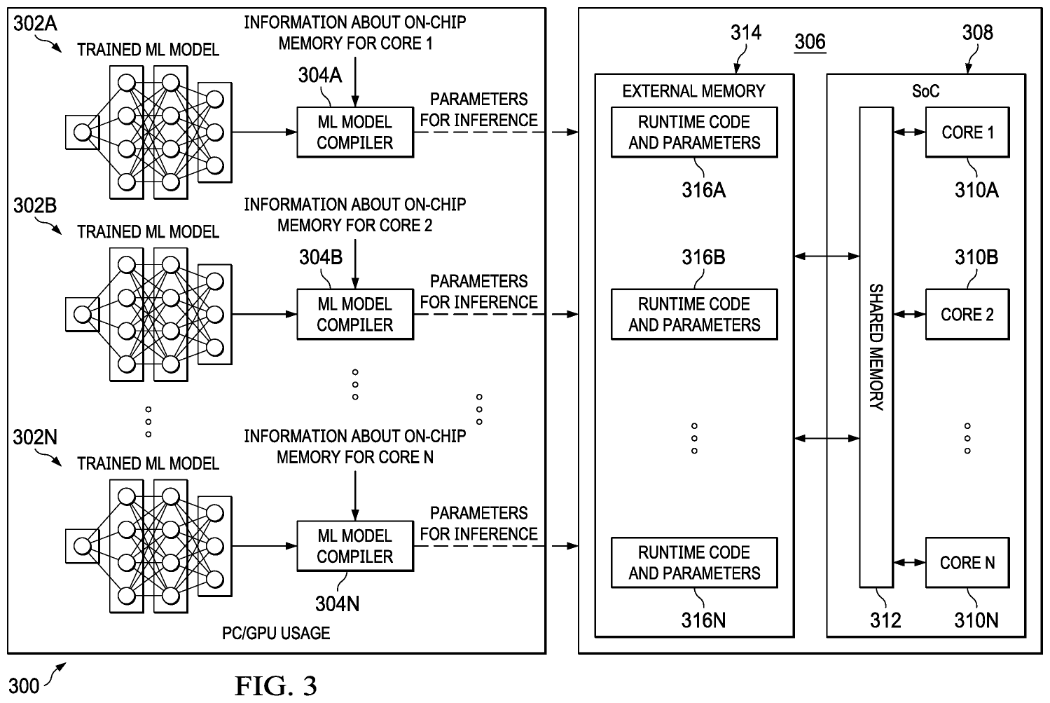

FIG. 3 is a block diagram 300 of a process for preparing ML models for target hardware, in accordance with aspects of the present disclosure. Machine learning models 302A, 302B . . . 302n (collectively 302) are trained during a training phase of development of the respective ML model 302. Training a ML model 302 teaches the ML model 302 to perform a task. For example, a ML model 302 for object recognition may be trained by presenting the ML model 302 with labeled images including an object, letting the ML model 302 attempt to identify the object in the image, and then adjusting parameters of the ML model 302, such as weights for layers of the ML model 302, based on how well the ML model 302 recognized the object.

Once a ML model 302 is trained, the ML model 302 may be compiled and translated for a target hardware by a ML model complier 304A, 304B, . . . 304n (collectively). In this example, the target hardware 306 is shown as a simplified version of the device shown in FIG. 2, and the target hardware 306 includes a SoC 308 with one or more cores 310A, 310B, . . . 310n, coupled to a shared memory 312. The SoC 308 is also coupled to external memory 314. The ML model compiler 304 helps prepare the ML model 302 for execution by the target hardware 306 by translating the ML model 302 to a runtime code 316A, 316B, . . . 316n (collectively 316) format that is compatible with the target hardware 306. The ML model compiler 304 may also parameterize the ML model 302 being compiled. In some cases, the ML parameters may include information that may be dynamically loaded from memory for executing the ML model 302, such as weights, layer ordering information, structure, etc. In cases with multiple ML models 302 executing on multiple cores 310, the ML model compiler 304 may determine which core 310 a ML model 302 should run on.

After compilation of the ML model 302 to runtime code 316 for the target hardware 306, the parameters of the ML model 302 may be stored, for example, in the external memory 314. When a ML model 302 is executed, the runtime code and parameters 316 may be loaded, for example into shared memory 312 or other memory, such as a memory dedicated to a specific ML core 310, and executed by the ML core 310. In some cases, a particular ML model 302 may be executed by a ML core 310 of the ML cores 310. Multiple ML models may be executed concurrently across the multiple ML cores. In some cases, certain ML models may be designated to execute on certain cores of the target hardware. For example, a ML model which uses more processing resources may be assigned to execute on a certain ML core which may have an increased amount of processing power, or multiple ML models which use less processing resources may be designated to execute together on another ML core.

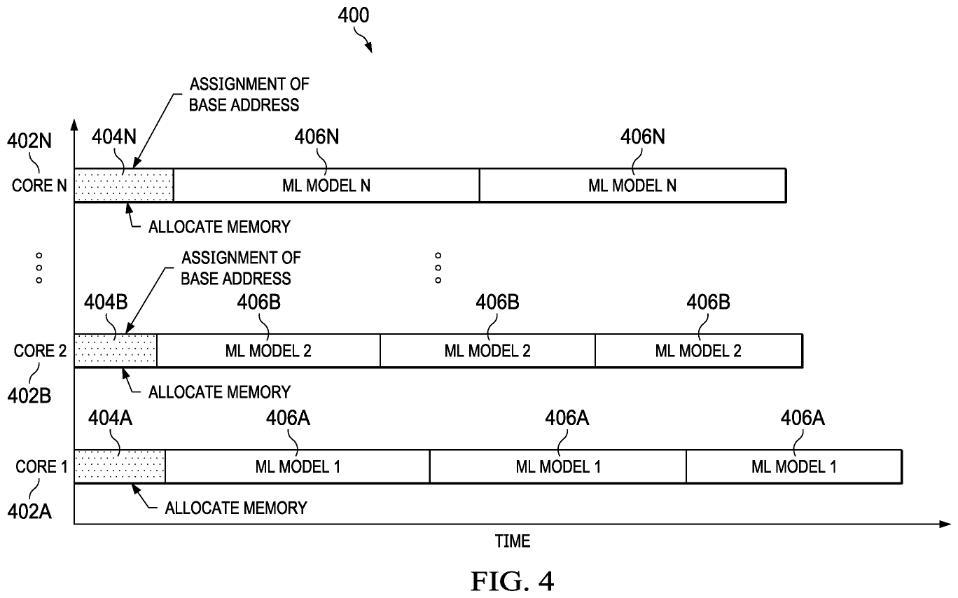

FIG. 4 is a timeline 400 illustrating ML model execution across the computing cores, in accordance with aspects of the present disclosure. The timeline 400 includes an X-axis plotting time, and a Y-axis plotting activities performed by the cores 402A, 402B, . . . 402N (collectively 402). In some cases, each of the cores 402 may include a general purpose CPU, a ML core, or other processor on which a ML model may be run. In some cases, each of the cores 402 may be a physical core or a logical core. When initializing a ML model, such as ML model 406A, for execution, memory, such as internal memory or external memory, may be allocated 404A for the ML model 406A prior to ML model 406A execution. In some cases, the ML core 402 on which a ML model 406 is executed may be determined prior to execution, for example during compilation or during initialization, and may be static once determined. That is, the core 402 on which a ML model 406 is run does not change once the ML model 406 is initialized on the core 402 until ML model 406 execution is stopped. As shown, the ML model 406A may continue to run on a particular core 402A after initialization. For example, a ML model for detecting faces may be run on frames of a video. In cases where the ML model is run on each frame of a 30 frame per second video, the ML model may be executed on a particular core, such as core 402A, 30 times per second. In some cases, multiple ML models may be executed on a single core 402. Other ML models, such as ML models 406B . . . 406N, may be initialized and continue to run on other cores, such as cores 402B, . . . 402N. These ML models 406 may execute concurrently and asynchronously. That is, multiple ML models 406 may run at the same time without synchronization as between the ML models 406.

Running multiple ML models concurrently and asynchronously may be associated with a linear scaling of hardware resources needed to run the ML models as ML models are added. For example, each ML model may be associated with a certain memory throughput requirement to load parameters needed by the ML model from memory. As the number of ML models increases, the amount of memory throughput increases linearly with the requirements of the ML models. In accordance with aspects of the present disclosure, optimization techniques may help reduce an amount of additional hardware resources needed to execute multiple ML models concurrently.

In some cases, which ML models will be executed concurrently may be known in advance. For example, a predetermined set of ML models may be run concurrently for use by a camera or another predetermined set of ML models may be run concurrently for an autonomous vehicle. Additionally, hardware resources required by a ML model may vary depending on a portion of the ML model being executed at a particular moment. For example, a ML model such as a deep learning or neural network model may include a number of layers. The hardware resources, for example processor time, memory capacity and throughput, power, etc., required for each layer may be different. In some cases, the execution of the multiple ML models executing on two or more logical computing cores may be sequenced across to balance the hardware resources required by the ML models.

ML Model Execution Optimization

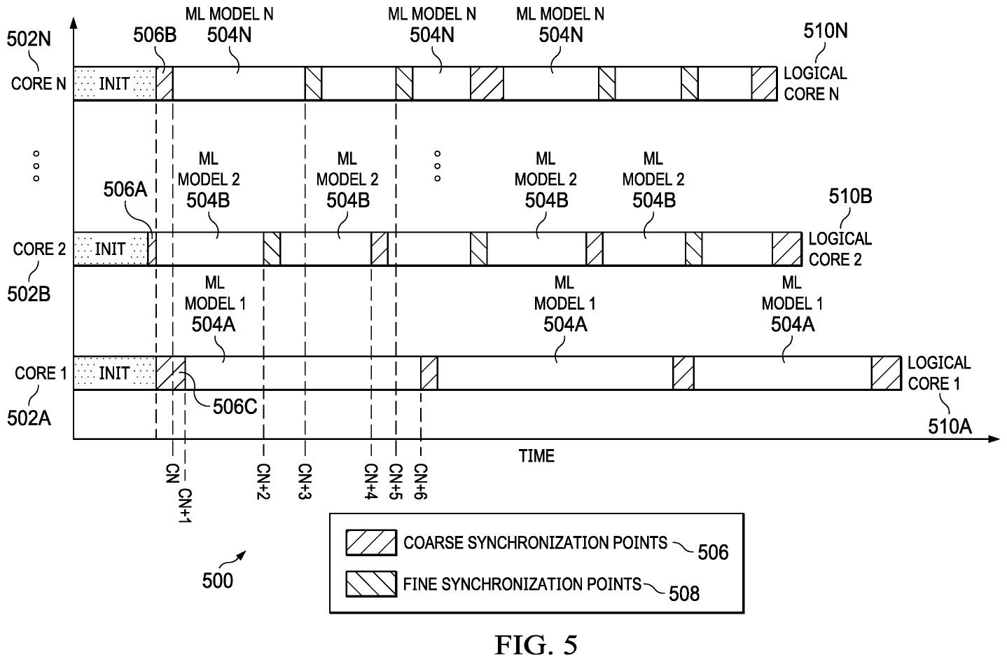

FIG. 5 is a timeline 500 illustrating ML model execution across the computing cores, in accordance with aspects of the present disclosure. The timeline 500 includes an X-axis plotting time, and a Y-axis plotting activity performed by the physical cores 502A, 502B, . . . 502N (collectively 502). In some cases, the physical cores 502 may include general purpose CPUs, ML cores, or other processors (or mix of processors) on which ML models may be run. In some cases, physical cores 502 may be mapped to logical cores. For clarity in this example, there is a one to one mapping of logical cores to physical cores such that physical core 1 502A is mapped to logical core 1 510A, physical core 2 mapped to logical core N−1 510B, and physical core N 502A mapped to logical core N 510N. In some cases, multiple logical cores 510 may be defined for a single physical core 502. For simplicity, in this disclosure, references to “cores” may be understood as referring to logical or physical cores. Synchronization points 506, 508 may be identified for running the ML models 504A, 504B, . . . 504N (collectively 504) on the cores 502. In some cases, synchronization points may be determined when preparing the ML models for the target hardware and synchronization pattern information about the synchronization points, such as where the synchronization points are located in the ML model, may be stored for use during run time. The synchronization points 506, 508 identify points at which execution of the ML models 504 on the cores 502 may be delayed to help align the execution of the ML models 504 across the cores 502. In some cases, coarse synchronization points 506 may be identified at the beginning (or end) of the ML models and fine synchronization points 508 may be identified as between layers of the ML models 504. Aligning the execution of the ML models 504 helps offset the peak resource requirements of the ML models 504. For example, ML model 1 504A and ML model 2 504B may both consume large amounts of memory in a first couple of layers. The memory usage may drop off, for example, after the initial couple of layers for ML model 2 504B.

Resource requirements of the ML models 504 may be balanced, for example, by adjusting an execution order of the ML models and/or an amount of time to delay execution of one or more ML models or portions of one or more ML model. For example, where ML model 2 504B consumes a relatively large amount of resources in a number of initial layers and then consumes relatively less resources after the initial layers, execution of ML model 1 504A may be scheduled after ML model 2 504B has started so that a high resource consumption period of ML model 1 504A does not coincide with the high resource consumption period of ML model 2 504B.

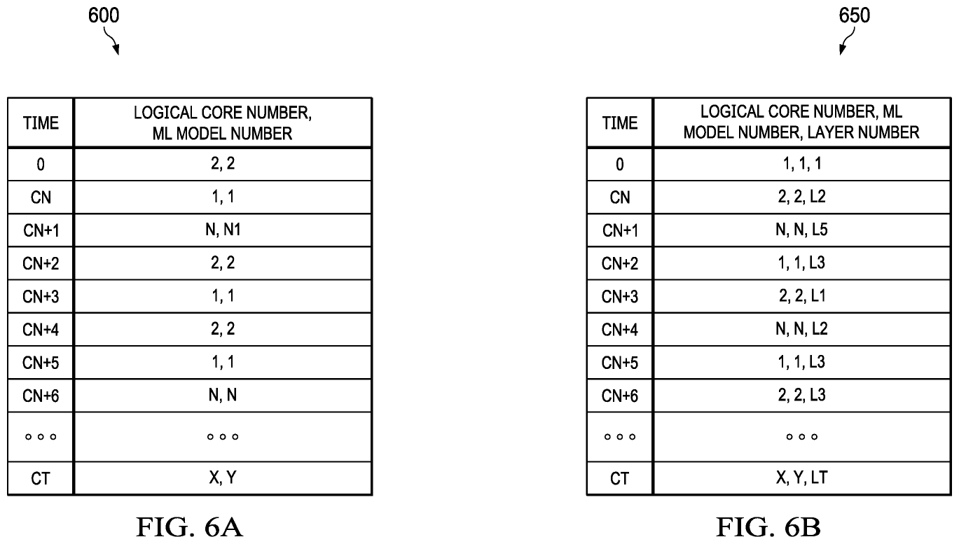

Additionally, a timing skew may be determined for the ML models 504. The timing skew may indicate an amount of time to delay for starting one or more ML models or an amount of time to delay execution of layers in one or more ML models. In some cases, these delays may be placed before/after/between runs of ML models or between layers of a ML model. In timeline 500, an amount of the timing skew may be represented by a size of the synchronization point. Continuing the example above, a first coarse sync point 506A for ML model 2 504B may represent a minimal or no delay where ML model 2 504B may be initiated at time 0. At a certain time indicated by the width of a second coarse sync point 506B, ML model n 504N may be initiated at time CN. Then at a certain time as indicated by the width of a third coarse sync point 506C, ML model 1 504A may be initiated at time CN+1. In some cases, multiple types of synchronization points 506, 508 may be identified. For example, coarse synchronization points 506 may be identified at the beginning (or end) of the ML models and fine synchronization points 508 may be identified as between layers of the ML models 504. In some cases, the execution order and timing skew for coarse synchronization points 508 and a timing skew for fine synchronization 508 may be determined, for example when preparing the ML model for the target hardware. In some cases, execution order and timing skew may also be adjusted at runtime. FIG. 6 helps illustrate how synchronization points 506, 508 are coordinated and FIGS. 5 and 6 are discussed together below.

FIGS. 6A and 6B are tables 600 and 650 illustrating context information for coordinating ML model execution, in accordance with aspects of the present disclosure. As shown, table 600 includes time information along with an associated core and ML model numbers. In some cases, the time information may be based on a hardware cycle, such as a number of clock ticks or clock counter. The core number associated with a time indicates the core a ML model is to be run on and the ML model number indicates which ML model to run. When preparing the ML models for the target hardware, the ML model may be assigned a number. Cores of the target hardware may also be mapped to core numbers and this mapping may also occur during preparation of the ML models for the target hardware. In some cases, the context information may be stored as a lookup table.

Multiple ML model execution may be dynamically coordinated based on context information and synchronization pattern information. In some cases, this coordination may be performed at a ML model level. For example, times at which certain ML models may be started on certain cores (e.g., for coarse synchronization points) may be provided as a part of the context and synchronization pattern information for dynamic coordination. Synchronization timing as between layers of the ML model may also be provided as pre-determined, fixed delays to be inserted between layers of the ML model. For example, a number and length of the delays as between layers of the ML model may be determined during the compilation and translation phase prior to execution and stored in a separate portion of the context information. This information may be accessed when executing the ML model, but not used to dynamically coordinate ML model synchronization. During execution of a ML model with inserted delays, when execution of the ML model reaches a fine synchronization point between layers, execution of the ML model may be delayed for the amount of time indicated in the inserted delay.

As shown in table 600, for dynamic coordination, a core number and ML model number may be associated with a time, indicating at which time a ML model should be run on which core. For example, a runtime controller may determine that a coarse synchronization point at the beginning of the ML models are been reached. In some cases, the runtime controller may determine when to start a ML model based on the context information and a current context index. Here, time 0 may represent an initial time value, such as a clock counter value. In some cases, a current context index may be incremented after each time is reach. The current context index can help track where execution is at in the context information and may be used to help determine a time value associated with the context information. The current context index may be initialized to point to the first entry of the context information corresponding to time 0. At time 0, execution of the first ML model may start. In this example, at time 0, ML model 2 504B may be the first ML model, of the ML models, started on core 2 502B. The current context index may be updated to point to time CN. A comparison of the current time and time CN may be performed and if the current time is less than CN, then starting the next ML model is delayed. At time CN, ML model 1 504A may be started on core 1 502A and the current context index may be updated to point to time CN+1. A comparison of the current time and time CN+1 may be performed and if the current time is less than CN+1, then starting the next ML model is delayed. At time CN+1, ML model N 504N may be started on core N 502N and the current context index may be updated to point to CN+2.

In some cases, the synchronization pattern information may also include synchronization information at a ML model layer level for coordinating ML models. Table 650 illustrates a variation of table 600 including layer coordination timings. Table 650 may be used in a manner similar to table 600 to help the runtime controller dynamically adjust timings for both coarse and fine synchronization points. Initially, at time 0, execution of the first ML model, here ML model 1 504A may be started at layer 1 on a first core 502A. As execution continues, a runtime controller may determine that a fine synchronization point located between certain layers of a ML model has been reached. Where the current context index is incremented after each time is reached, the current context index, in this example, would point to time CN and time CN is the next time value after the initial time. This next time value may be compared to a current time value. If the current time is less than the next time value, then execution of the ML model layer associated with the next time value, here layer 2 of ML model 2 504B may be delayed at the reached fine synchronization point until the current time matches CN. Execution of ML model 2 504B on core 2 502B may then proceed when the current time matches or exceeds CN. The current context index may be incremented to point to CN+1 and when execution of ML model N 504N reaches a next fine synchronization point at layer 5, the current time value is compared to time CN+1 to determine whether to delay execution of layer 5 of ML model N 504N on core N 502N, or continue execution in the same manner as discussed above with respect to time CN0. In some cases, synchronization at a beginning of a ML model (e.g., coarse synchronization) may be indicated by a layer number set to the first layer of the ML model, such as shown at time CN+3. Synchronization of ML models may continue in such a manner until T number of entries in the context information is reached. In some cases, after T number of entries are reached, the current context index is moved to the first entry of the context information. A new initial time value may be determined, and synchronization of the ML models based on the context information may be repeated.

In some cases, executing a ML model on simulated target hardware and based on simulated inputs may not exactly match execution of the ML model on the target hardware with real-world inputs. In some cases, a ML model may execute in less time than expected. In such cases, execution of the ML model may be delayed as discussed above. In other cases, execution of the ML model may take longer than expected and adding additional delays in such case may be skipped. In cases where execution of the ML model takes much longer than expected, such as if, for example, execution of ML model 2 504B reaches the synchronization point associated with time CN+2 after time CN+2 has elapsed, additional flexibility in the synchronization of the ML models may be provided. In accordance with aspects of the present disclosure, a leaky bucket scheme may be used to provide a more flexible synchronization scheme to help optimize performance.

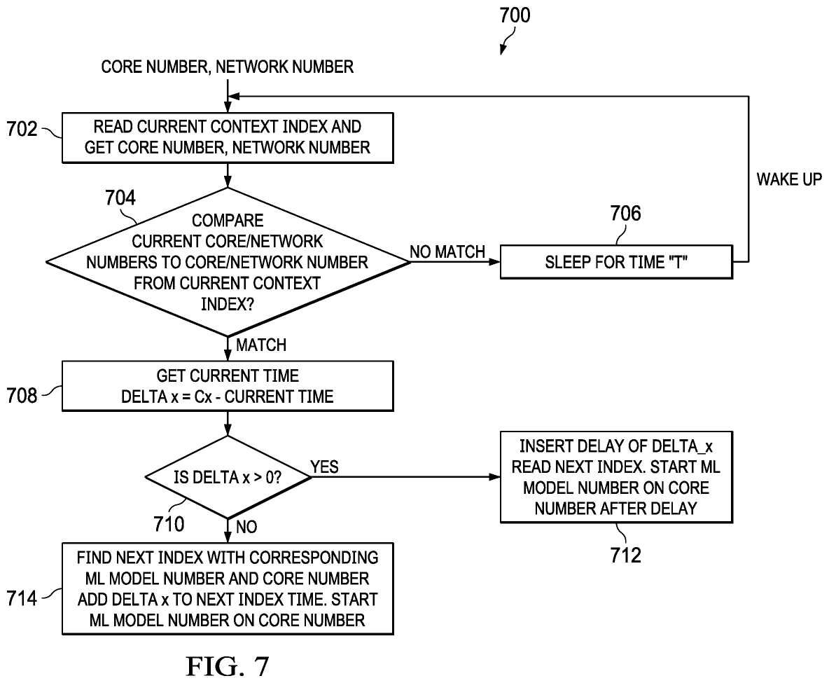

FIG. 7 is a flowchart 700 illustrating a leaky bucket optimization scheme, in accordance with aspects of the present disclosure. Flowchart 700 illustrates steps that may be performed on a per core basis. In some cases, these steps may be performed by a hardware or software ML model runtime controller for a core when a synchronization point is reached after the ML model is initialized on the core. At step 702, a core number and ML model number may be read from the context information based on a current context index. As indicated above, the context information helps track where execution is at in the context information. At step 704, the core number and ML model number from the context information at a particular context index is compared to the core number of the current core and a ML model number of the ML model currently executing on the current core. If the core and ML model numbers read from the context information do not match the current core and ML model numbers, at step 706, the core may sleep for a time interval T before returning to step 702 to continue execution. In some cases, the time interval T may be based on a minimum time interval of the context information. In cases where the ML model execution delays (e.g., sleep) are software implemented, the delays may be implemented via callback functions to help avoid possible task switching while the ML model is paused. In some cases, callback functions may be implemented in a software function, such as the runtime code, and call into other, external, functionality. In cases where the ML model delays are hardware implemented, the delays may be implemented as parallel threads to threads used by the ML model.

If, at step 704, the core number of the current core and a ML model number of the ML model currently executing on the current core match the core and ML model numbers read from the context information, then the current time is obtained and a difference between then the time read from a current context index of the context information (Cx) and the current time is determined at step 708. At step 710, if the time read from the context information (Cx) is greater than the current time, then at step 712, a delay equal to the difference between the time read from the context information (Cx) and the current time is set, the next context index is read in preparation for advancing the current context index, and the corresponding ML model is started or continued on the core after the delay. If the time read from the context information (Cx) is less than the current time, execution of the ML model on the core is occurring slower than expected. To help expedite execution, at step 714, the next entry for the core and ML model numbers are found and the corresponding time is updated based on the difference between the time read from the context information (Cx) and the current time. Execution of the corresponding ML model is started, or continued, on the core, skipping the delay.

As described above, a ML model runtime controller of a core may update the context information based on the when execution of a ML model reaches a synchronization point as compared to when the ML model was expected to reach the synchronization point. To help avoid conflict issues where multiple cores attempt to update the context information at once, a core may lock write access to the context information when the core is attempting to update the context information.

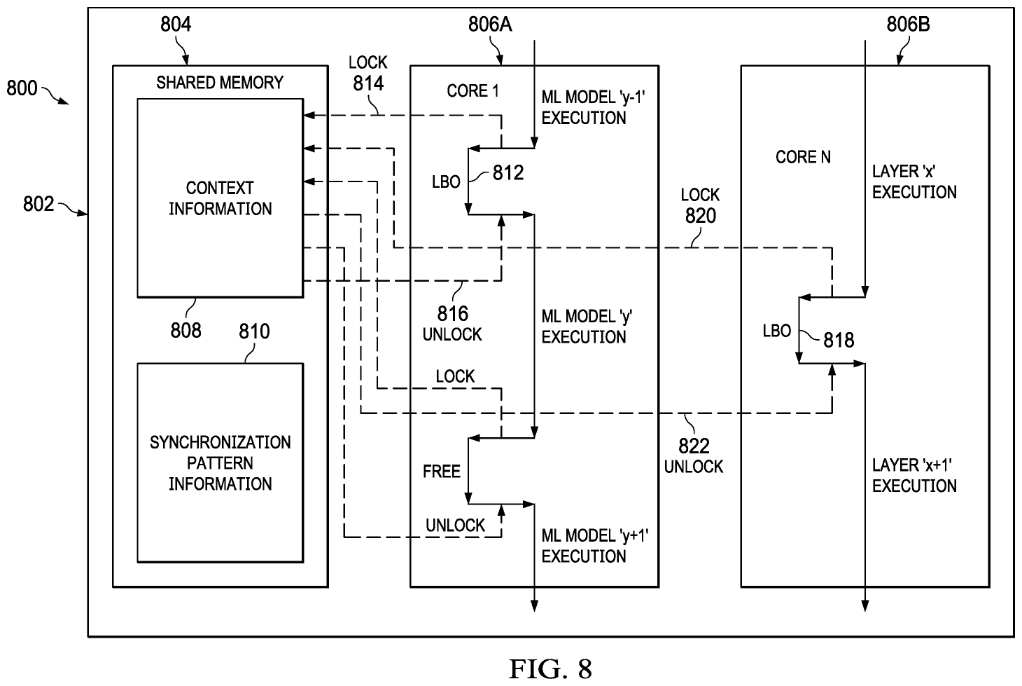

FIG. 8 is a block diagram 800 illustrating context information locking, in accordance with aspects of the present disclosure. The block diagram 800 illustrates a simplified representation of the target hardware 802 including a shared memory 804 and two representative cores 806A and 806n executing ML models. Context information 808 and synchronization pattern information 810 may be stored in the shared memory 804. As shown, core 1 806A may finish executing ML model y−1 and enter a synchronization point 812, for example, before beginning execution of ML model y. Core 1 806A may read the context information to determine whether the current context index is associated with ML model y and core 1 806A. In some cases, read access to the context information may be permitted even if another core has the context information locked for writing. If core 1 806A determines that the current context information is associated with ML model y and core 1 806A, the core 1 806A may request a write lock 814 on the context information. After the core 1 806A receives an indication that the write lock 814 was placed successfully, the core 1 806A may update the context information based on the results of the leaky bucket optimization scheme and unlock 816 the context information for writing.

Similarly, core N 806B may be executing a ML model and hit a synchronization point 818 between layers x and x+1. Core N 806B may read the context information to determine whether the current context index is associated with ML model x and core N 806B. If the current context information is associated with ML model x and core N 806B, the core N 806B may request a write lock 820 on the context information. After the core N 806B receives an indication that the write lock 820 was placed successfully, the core N 806B may update the context information based on the results of the leaky bucket optimization scheme and unlock 822 the context information for writing.

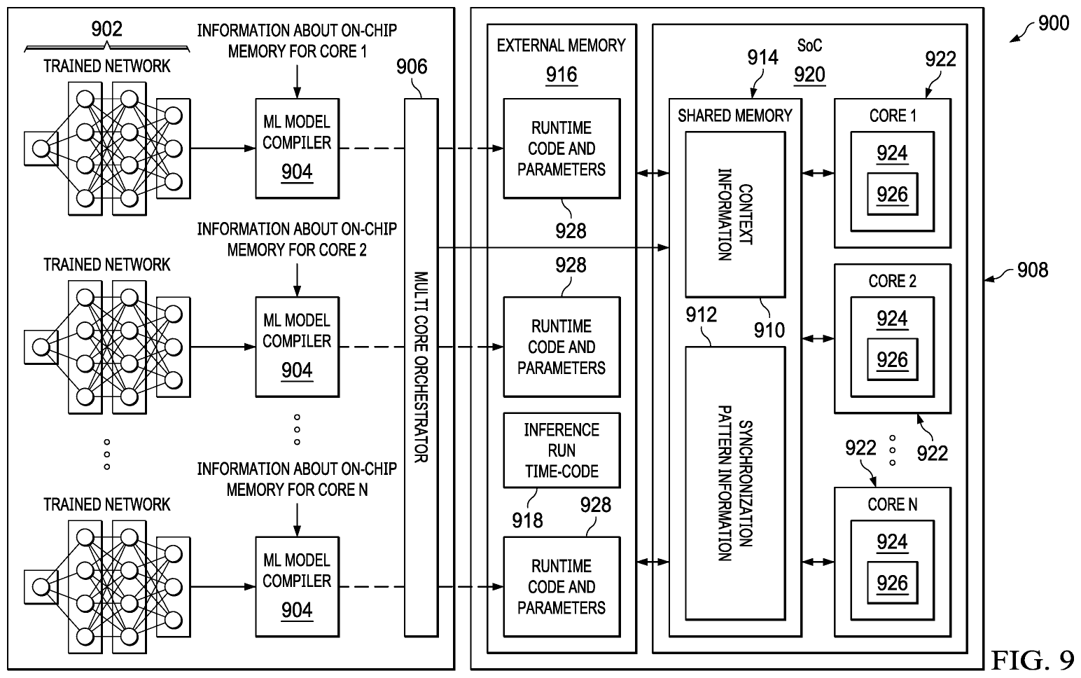

In some cases, the context information and synchronization pattern information may be determined as a part of preparing the ML models to execute on target hardware. FIG. 9 is a block diagram 900 of a process for optimizing ML models, in accordance with aspects of the present disclosure. As shown, trained ML models 902 may be compiled and translated for a target hardware by a ML model complier 904. A multi-core orchestrator 906 may generate the context information 910 and synchronization pattern information 912. The multi-core orchestrator 906 may simulate the execution of the ML models 902 on the target hardware. In some cases, the simulation may be subject to a number of constraints. In some cases, these constraints may be external memory bandwidth, amount of power needed, memory bandwidth, and memory sizes. In some cases, memory bandwidth and memory sizes may also take into consideration the specific types of memories available on the target hardware. In some cases, training the ML networks, compiling and translating the ML networks, and orchestrating the ML networks may be performed by one or more devices separate from the target hardware. In some cases, the multi-core orchestrator module 906 may be integrated with the ML model compilation and translation, or run separate from and in addition to the compilation and translation.

To help the multi-core orchestrator 906 determine where to insert delays and how long delays should be, the multi-core orchestrator 906 simulates the ML models 902 to characterize the ML models 902. In some cases, the ML models may each be characterized on a layer by layer basis to determine, for each layer, an amount of time needed to execute the layer, an amount of external memory bandwidth needed to execute the layer, an amount of power needed to execute the layer, an amount of needed to execute the layer, and an amount of bandwidth needed to execute the layer.

In some cases, multi-core orchestrator 906 may determine where to insert delays and how long delays should be for the synchronization pattern information 912 and context information 910 based on one or more cost functions. After characterizing the ML models, the multi-core orchestrator 906 may then insert a set of one or more delays in between certain layers and/or delay the start times of certain ML models and evaluate the inserted delays based on one or more cost functions.

In some cases, a first cost function may apply a certain weight to each of the constraints. For example, a first weight may be applied to the amount of external memory bandwidth needed, a second weight applied to the amount of power needed, a third weight applied to the amount of needed, and a fourth weight applied to amount of bandwidth needed. A second cost function may be a sum of all of the delays being applied across all of the cores. This second cost function may be minimized to help avoid adding delays which slow down execution of the ML models. Other cost functions may also be used, including per-core cost functions, such as a sum of all delays introduced on a per-core basis.

For a set of inserted delays, a value of each cost function may be determined. In some cases, an overall cost value for the set of inserted delays may also be determined. The overall cost value may be determined based on applying weights to each cost function and then summing the weighted cost functions. Another set of one or more inserted delays may be determined and the steps repeated to determine values for each cost function and overall cost value. In some cases, sets of one or more inserted delays may be repeatedly evaluated exhaustively and from this exhaustive set, a set of inserted delays which minimizes the overall cost value may be selected and used to generate the context information 910 and synchronization pattern information 912. The context information 910 and synchronization pattern information 912 may be stored on a computer-readable medium for use with the ML models.

After generation, the context information 910 and synchronization pattern information 912 may be stored in an external memory 916 of the target hardware 908. In some cases, the context information 910 and synchronization pattern information 912 may be stored as a part of, or with, other optimization runtime code 918. The external memory 916 is coupled to a SoC 920 and at runtime of the ML models, the context information 910 and synchronization pattern information 912 may be loaded from the external memory 916 into a shared memory 914 of the SoC 920 of the target hardware 908. In some cases, one or more portions of the context information 910 and synchronization pattern information 912 may also be stored or accessed from an external memory 916 of the target hardware 908 during runtime. Runtime code 928 for the ML models on the target hardware 908 may also be stored in the external memory 916. During runtime of the ML models, the execution of the ML models may be controlled by runtime controllers 924 on the cores 922 of the SoC 920. A timing manager 926 of the runtime controller 924 may be provided to detect synchronization points, start, pause, and resume execution of ML models, and/or perform leaky bucket optimization determinations.

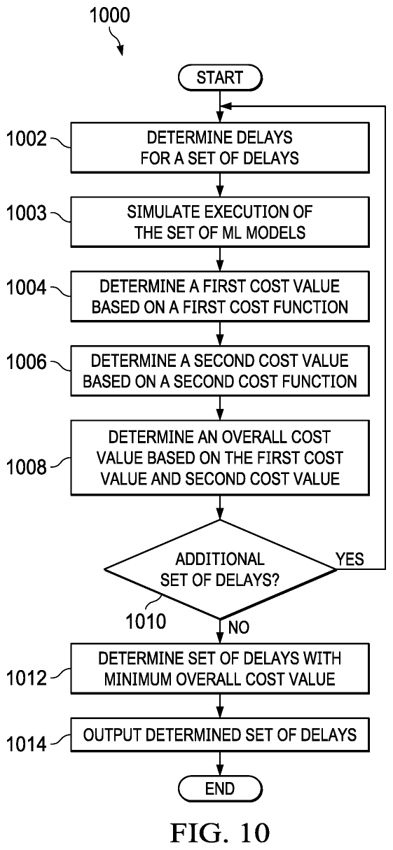

FIG. 10 is a flow diagram 1000 illustrating a technique for optimizing delay timing, in accordance with aspects of the present disclosure. At block 1002, delay values for a set of delays may be determined for a set of ML models. For example, an orchestrator may select an initial set of delay timings to apply to synchronization points of the ML models. At block 1003, execution of the set of ML models may be simulated to obtain information related to the execution of the set of ML models. For example, the orchestrator, such as the multi-core orchestrator of FIG. 9, may simulate the execution of the set of ML models to determine delay timings. These simulations characterize the aspects of the ML model execution to obtain information related to the execution of the ML model, such as an amount of external memory bandwidth used by the ML models, power consumed to execute the ML models, amount of internal memory throughput used by the ML models, and/or an amount of internal memory used by the ML models.

At block 1004, a first cost value based on a first cost function may be determined based on the information related to the execution of the set of ML models. In some cases, this cost function may be based on the information related to the execution of the ML models. In some cases, the cost function may be a weighted sum of the information related to the execution of the ML model. For example, the ML models may be simulated with a certain set of delay timings applied to the ML models and a set of information determined, such as maximum amount of external memory bandwidth (B), power consumed (P), internal memory throughput (T), and amount of internal memory (S) used may be determined. Each type of information may be weighted (W), for example, by multiplying by a weight and then summed to obtain the first cost value. In some cases, each type of information may have a different weight. Thus, a first cost function to obtain a first cost value (C1) may be, in this example, C1=W1*B+W2*P+W3*T+W4*S. In some cases, the weights may be constrained. For example, sum of the weights may be equal to 1 (e.g., W1+W2+W3+W1=1).

At block 1006, a second cost value based on a second cost function may be determined. In some cases, this second cost function may be based on a sum of the applied delays. For example, the second cost function determine the second cost value (C2) by summing an amount of delay time applied to all of the synchronization points of the ML models added across all of the cores. In another example, the second cost function may determine the second cost value (C2) by summing an amount of delay time applied to all of the synchronization points of the ML models that would execute on particular cores of the target hardware (e.g., delay times applied for ML model(s) executing on core 1).

At block 1008, an overall cost value may be determined based on the first cost value and the second cost value. For example, the first cost value and the second cost value may be weighted (Wc) and then summed such that the overall cost for a particular set of delay timings are Wc1*C1+Wc2*C2. At block 1010, overall costs for additional sets of delay timings may be looped through. In some cases, the orchestrator may simulate the execution of the set of ML models based on a set of parameters, such as a delay range or a maximum delay for coarse and/or fine synchronization points. The orchestrator may perform an exhaustive set of simulations, for example over each delay timing and combination of delay timings for the synchronization points, of a set of delay timings, within the delay range or below a maximum delay, for synchronization points of the ML models and overall cost values determined for each set of delay timings.

After overall cost values are determined for each set of delay timings, at block 1012, a set of delay timings associated with a minimum overall cost value is determined and at block 1014, the determined delay timings associated with the minimum overall cost value may be output. For example, the determined delay timings may be used for the synchronization pattern and/or context information.

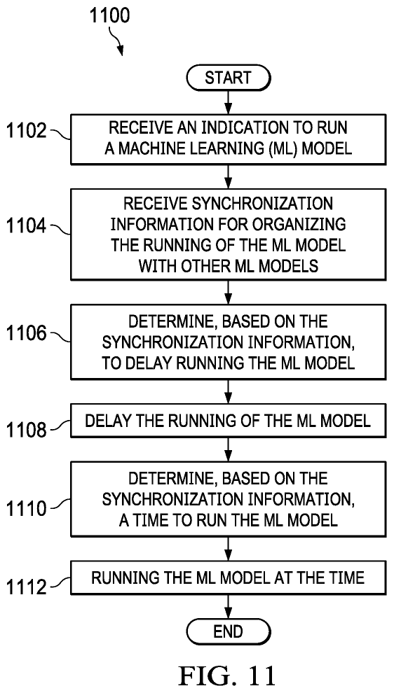

FIG. 11 is a flow diagram 1100 illustrating a technique for synchronizing a ML model, in accordance with aspects of the present disclosure. At block 1102, an indication to run a machine learning (ML) model is received. For example, a runtime controller of a processor may receive an indication to start executing a ML model. At block 1104, synchronization information for organizing the running of the ML model with other ML models is received. For example, context information and synchronization pattern information associated with the ML model may be loaded. At block 1006, the runtime controller determines, based on the synchronization information, to delay running the ML model. For example, a timing manager of the runtime controller may determine to insert delays before beginning execution of a ML model or between layers of a ML model (e.g., at a beginning of a layer boundary). At block 1008, the running of the ML model may be delayed. For example, based on the synchronization information, execution of the ML model may be delayed. At block 1010, based on the synchronization information, a time to run the ML model may be determined. For example, the timing manager may determine a time to start or resume executing the ML model. At block 1012, the ML model is run at the determined time. For example, execution of the ML model may be started or resumed at the determined time.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Modifications are possible in the described embodiments, and other embodiments are possible, within the scope of the claims.

What is claimed is:

1. A method, comprising:
receiving an indication to run a first machine learning (ML) model;
receiving synchronization information for organizing the running of the first ML model with respect to a second ML model;
determining, based on the synchronization information, a time to run the first ML model; and
running the first ML model at the time.

2. The method of claim 1, wherein the synchronization information includes timing information and an associated indication of the first ML model and a core.

3. The method of claim 1, wherein the running of the first ML model at the time comprises inserting a delay before beginning to run the ML model.

4. The method of claim 3, wherein the delay is based on a callback function or a parallel thread.

5. The method of claim 1, wherein the determining of the time to run the first ML model comprises determining whether to insert a delay between layers of the ML model.

6. The method of claim 1, wherein the determining of the time to run the ML model comprises determining a difference between an expected time to run the ML model and a current time; and wherein the method comprises beginning the run of the ML model based on the difference.

7. The method of claim 6, further comprising adjusting a next expected time to run the ML model based on the difference.

8. The method of claim 6, wherein the determining of the time to run the first ML model further comprises removing the delay of the running of the ML model based on the difference.

9. A non-transitory program storage device comprising instructions stored thereon to cause one or more processors to:
receive a set of ML models;
simulate running the set of ML models on a target hardware to determine resources utilized by running the ML models of the set of ML models and timing information;
determine to delay running a subset of the set of ML models based on the simulation; and
generate synchronization information based on the determining.

10. The non-transitory program storage device of claim 9, wherein the target hardware includes at least two cores for executing ML models and wherein the synchronization information includes timing information for coordinating execution of the ML models across the at least two cores.

11. The non-transitory program storage device of claim 10, wherein the synchronization information includes timing information and an associated indication of a ML model, of the ML models, and a core of the target hardware.

12. The non-transitory program storage device of claim 10, wherein the synchronization information is organized in a lookup table.

13. The non-transitory program storage device of claim 9, wherein delaying running of the ML model comprises inserting a delay before beginning to run the ML model.

14. The non-transitory program storage device of claim 9, wherein delaying running of the ML model comprises inserting a delay between layers of the ML model.

15. The non-transitory program storage device of claim 9, wherein determining to delay the running one or more ML models is based on one or more cost functions.

16. The non-transitory program storage device of claim 15, wherein a cost function of the one or more cost functions is based on at least one of a memory bandwidth, an amount of power consumed, and a size of available memory.

17. The non-transitory program storage device of claim 15, wherein a cost function of the one or more cost functions is based on an amount of delays added to the ML models.

18. The non-transitory program storage device of claim 9, wherein simulating running the set of ML models on the target hardware comprises determining at least an amount of memory bandwidth, power, and memory size used when executing the set of ML models on the target hardware.

19. An electronic device, comprising:
a memory; and
one or more processors operatively coupled to the memory, wherein the one or more processors are configured to execute instructions causing the one or more processors to:
receive an indication to run a first machine learning (ML) model;
receive synchronization information for organizing the running of the first ML model with respect to a second ML model;
determine, based on the synchronization information, a time to run the first ML model; and
run the first ML model at the time.

20. The device of claim 19, wherein the running of the ML model comprises inserting a delay before beginning to run the ML model or between layers of the ML model.
